(19) United States
(12) Patent Application Publication
(10) Pub. No.: US 2012/0219332 A1
(43) Pub. Date: Aug. 30, 2012

(54) DEVELOPER SUPPLY DEVICE AND IMAGE FORMING APPARATUS HAVING THE SAME

(75) Inventors: Keisuke TAKAHASHI, Nagoya (JP); Kenjiro NISHIWAKI, Nagoya (JP)

(73) Assignee: BROTHER KOGYO KABUSHIKI KAISHA, Aichi (JP)

(21) Appl. No.: 13/362,531

(22) Filed: Jan. 31, 2012

(30) Foreign Application Priority Data
Feb. 25, 2011 (JP) 2011-040529

(51) Int. Cl. G03G 15/08

(52) U.S. Cl. 399/281; 399/283

(57) ABSTRACT

A developer supply device configured to supply charged development agent to an intended device is provided, the developer supply device including a developer storage section storing the development agent, an electric-field transfer board that includes transfer electrodes arranged along a developer transfer path in parallel with each other, and transfers the development agent stored in the developer storage section along the developer transfer path when the transfer electrodes are supplied with a multi-phase alternating-current voltage, and a brush roller that is disposed to face the intended device in a predetermined developer supply position and face the electric-field transfer board in a predetermined developer carrying position, and configured to receive the development agent from the electric-field transfer board in the predetermined developer carrying position and carry the received development agent to the predetermined developer supply position where the development agent is supplied to the intended device.

### CROSS-REFERENCE TO RELATED APPLICATION

This application claims priority under 35 U.S.C. §119 from Japanese Patent Applications No. 2011-040529 filed on Feb. 25, 2011. The entire subject matter of the application is incorporated herein by reference.

### BACKGROUND

1. Technical Field

The following description relates to one or more techniques for supplying development agent to an intended device.

2. Related Art

A developer supply device that employs a fur brush development method has been known. The developer supply device is configured to supply development agent to an intended device (e.g., a photoconductive drum) using a brush roller that has a number of fibers provided on a circumferential surface thereof. For example, in order to supply the brush roller with the development agent, the brush roller may be disposed to face a developer storage section or disposed to contact a supply roller.

### SUMMARY

The known developer supply device has a problem that a charge state of charged development agent carried on the brush roller is too unstable to supply the development agent to the intended device in a favorable manner (i.e., too unstable to develop an electrostatic latent image in a favorable manner).

Aspects of the present invention are advantageous to provide one or more improved techniques for providing an inexpensive developer supply device configured to render stable a charge state of charged development agent carried on a brush roller as effectively as practicable and supply the development agent to an intended device in a favorable manner.

According to aspects of the present invention, a developer supply device configured to supply charged development agent to an intended device is provided, the developer supply device including a developer storage section configured to store the development agent to be supplied, an electric-field transfer board including a plurality of transfer electrodes arranged along a developer transfer path in parallel with each other, the electric-field transfer board being configured to transfer the development agent stored in the developer storage section along the developer transfer path when the plurality of transfer electrodes are supplied with a multi-phase alternating-current voltage, and a brush roller disposed to face the intended device in a predetermined developer supply position and face the electric-field transfer board in a predetermined developer carrying position, the brush roller being configured to receive the development agent from the electric-field transfer board in the predetermined developer carrying position and carry the received development agent to the predetermined developer supply position where the development agent is supplied to the intended device.

According to aspects of the present invention, further provided is an image forming apparatus, which includes an image carrying body configured to carry an electrostatic latent image, and a developer supply device configured to supply charged development agent to the image carrying body to develop the electrostatic latent image carried on the image carrying body, the developer supply device including a developer storage section configured to store the development agent to be supplied, an electric-field transfer board including a plurality of transfer electrodes arranged along a developer transfer path in parallel with each other, the electric-field transfer board being configured to transfer the development agent stored in the developer storage section along the developer transfer path when the plurality of transfer electrodes are supplied with a multi-phase alternating-current voltage, and a brush roller disposed to face the intended device in a predetermined developer supply position and face the electric-field transfer board in a predetermined developer carrying position, the brush roller being configured to receive the development agent from the electric-field transfer board in the predetermined developer carrying position and carry the received development agent to the predetermined developer supply position where the development agent is supplied to the intended device.

### BRIEF DESCRIPTION OF THE ACCOMPANYING DRAWINGS

FIG. 1 is a cross-sectional side view schematically showing a configuration of a laser printer in an embodiment according to one or more aspects of the present invention.

FIG. 2 is an enlarged cross-sectional side view of a toner supply device for the laser printer in the embodiment according to one or more aspects of the present invention.

FIG. 3 is an enlarged cross-sectional side view of an electric-field transfer board for the toner supply device in the embodiment according to one or more aspects of the present invention.

FIG. 4 exemplifies waveforms of voltages generated by power supply circuits for the electric-field transfer board in the embodiment according to one or more aspects of the present invention.

FIG. 5 is an enlarged cross-sectional side view of a toner supply device for the laser printer in a modification according to one or more aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect.

Hereinafter, an embodiment according to aspects of the present invention will be described with reference to the accompany drawings.

### <Configuration of Laser Printer>

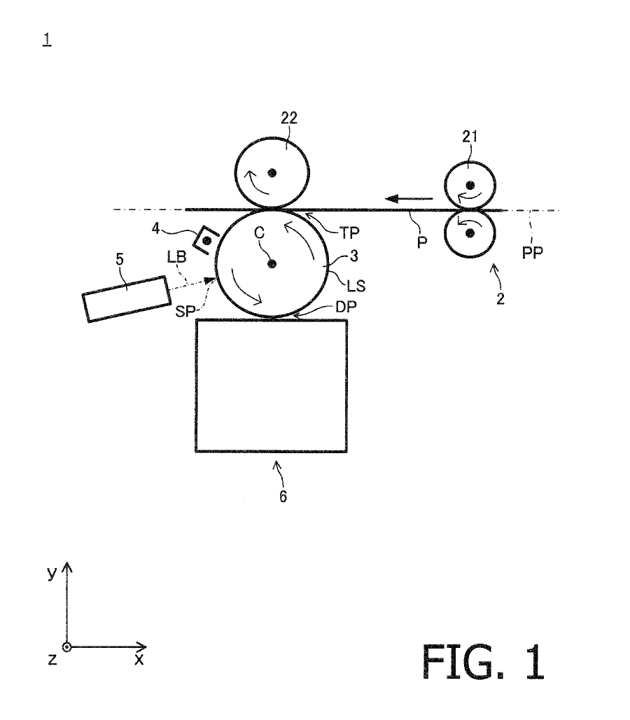

As illustrated in FIG. 1, a laser printer 1 includes a sheet feeding mechanism 2, a photoconductive drum 3, an electrification device 4, a scanning unit 5, and a toner supply device 6. The laser printer 1 further includes therein a feed tray (not shown) configured to accommodate sheets P stacked thereon. The sheet feeding mechanism 2 is configured to feed a sheet P along a predetermined sheet feeding path PP.

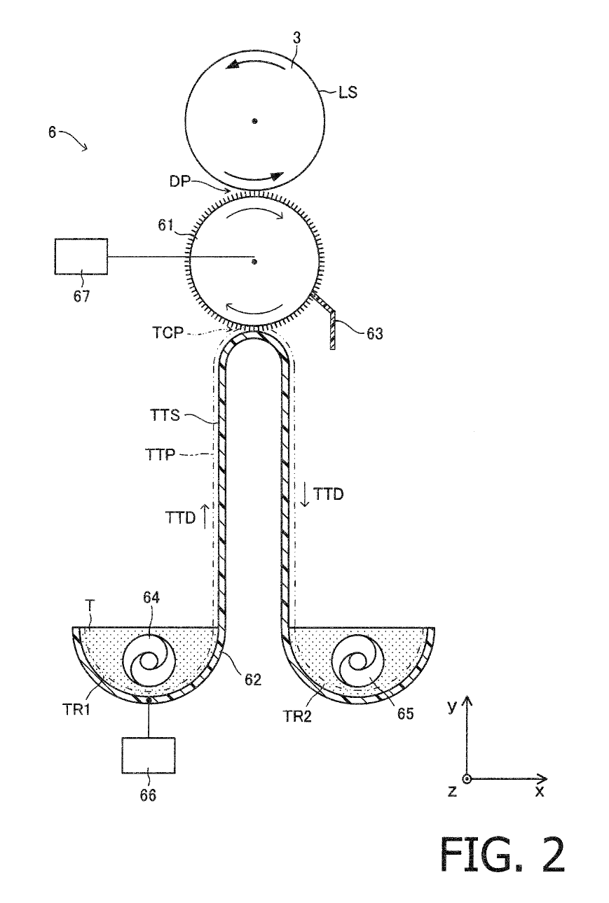

On a circumferential surface of the photoconductive drum 3, an electrostatic latent image carrying surface LS is formed as a cylindrical surface parallel to a main scanning direction (i.e., a z-axis direction in FIG. 1). The electrostatic latent image carrying surface LS is configured such that an electrostatic latent image is formed thereon in accordance with an electric potential distribution. Further, the electrostatic latent image carrying surface LS is configured to carry toner T (see FIG. 2) in positions corresponding to the electrostatic latent image. The photoconductive drum 3 is driven to rotate in a counterclockwise direction indicated by arrows in FIG. 1 around an axis parallel to the main scanning direction. Thus, the photoconductive drum 3 is configured to move the electrostatic latent image carrying surface LS along an auxiliary scanning direction (typically, an x-axis direction in FIG. 1) perpendicular to the main scanning direction.

The electrification device 4 is disposed to face the electrostatic latent image carrying surface LS. The electrification device 4, which is of a corotron type or a scorotron type, is configured to evenly and positively charge the electrostatic latent image carrying surface LS (for instance, in the embodiment, such that an electrical potential of the electrostatic latent image carrying surface LS becomes +700 V).

The scanning unit 5 is configured to generate a laser beam LB modulated based on image data. Specifically, the scanning unit 5 is configured to generate the laser beam LB within a predetermined wavelength range, which laser beam LB is emitted under ON/OFF control depending on whether there is a pixel (an image element) in a target location on the image data. In addition, the scanning unit 5 is configured to converge the laser beam LB in a scanned position SP on the electrostatic latent image carrying surface LS and move (scan) the convergence point of the laser beam LB along the main scanning direction at a constant speed. Here, the scanned position SP is set in a position downstream relative to the electrification device 4 and upstream relative to the toner supply device 6 in the rotational direction of the photoconductive drum 3. In the embodiment, the scanning unit 5 is adapted to form an electrostatic latent image containing an electric potential distribution with an exposed area of +150 V and an unexposed area of +700 V when the aforementioned laser beam LB is emitted onto the electrostatic latent image carrying surface LS evenly charged by a voltage of +700 V.

The toner supply device 6 is disposed under the photoconductive body 3 so as to face the electrostatic latent image carrying surface LS. The toner supply device 6 is configured to supply the positively charged toner T (see FIG. 2), in a development position DP (where the toner supply device 6 is opposed to and in closest proximity to the electrostatic latent image carrying surface LS), onto (the electrostatic latent image carrying surface LS of) the photoconductive drum 3. It is noted that in the embodiment, the toner T is positively-chargeable nonmagnetic-one-component black toner. A detailed explanation will be provided later about the configuration of the toner supply device 6.

Subsequently, a detailed explanation will be provided about a specific configuration of each of elements included in the laser printer 1.

The sheet feeding mechanism 2 includes two registration rollers 21, and a transfer roller 22. The registration rollers 21 are configured to feed a sheet P toward between the photoconductive drum 3 and the transfer roller 22 at a predetermined moment. The transfer roller 22 is disposed to face the electrostatic latent image carrying surface LS across the sheet feeding path PP in a transfer position TP. Additionally, the transfer roller 22 is driven to rotate in a clockwise direction indicated by an arrow in FIG. 1. The transfer roller 22 is connected to a transfer power supply circuit (not shown), such that a predetermined transfer bias voltage is applied to between the transfer roller 22 and the photoconductive drum 3 so as to transfer, onto the sheet P, the toner T (see FIG. 2) adhering onto the electrostatic latent image carrying surface LS.

### <<Toner Supply Device>>

As shown in FIG. 2, which is a cross-sectional side view (a cross-sectional view along a plane with the main scanning direction as a normal line) of the toner supply device 6, the toner supply device 6 includes a toner box 61, which forms a casing of the toner supply device 6, is a box-shaped member. The toner box 61 includes a development roller 61, an electric-field transfer board 62, a retrieving member 63, augers 64 and 65, a transfer bias supply circuit 66, and a development bias supply circuit 67.

The development roller 61 is a brush roller that includes a number of fibers formed to radially extend from a cylindrical circumferential surface of the roller. Specifically, in the embodiment, the development roller 61 includes a metal roller made of metal such as aluminum, and nylon fibers (fiber size: 3 denier, fiber density: 120,000 fibers per inch squared, fiber length: 5 mm, and fiber resistance: 105-108 Ω·cm) formed to radially extend from a circumferential surface of the metal roller. Further, the development roller 61 is provided to softly contact the photoconductive drum 3 (so as to make the fibers slightly bend) in the development position. Moreover, the development roller 61 is driven to rotate clockwise in FIG. 2 (i.e, in an opposite direction to the rotational direction of the photoconductive drum 3) such that a circumferential surface of the development roller 61 moves in the same direction as the moving direction of the electrostatic latent image carrying surface LS in the development position DP.

The electric-field transfer board 62 is disposed to face the development roller 61 in a toner carrying position TCP. In the embodiment, the electric-field board 62 is provided to softly contact the development roller 61 (so as to make the fibers slightly bend) in the toner carrying position TCP. The electric-field transfer board 62 is configured to transfer the toner T along a toner transfer path TTP (i.e., a transfer path for the toner T that is formed along a toner transfer surface TTS as a surface of the electric-field transfer board 62) by a traveling-wave electric field, which is generated when the electric-field transfer board 62 is supplied with a transfer bias containing a direct-current (DC) voltage component and multi-phase alternating-current (AC) voltage components. An internal configuration of the electric-field transfer board 62 will later be described in detail.

In the embodiment, the electric-field transfer board 62 is configured to transfer the toner T stored in a toner storage room TR1 toward the toner carrying position TCP, supply the toner T to the development roller 61 in the toner carrying position TCP, and transfer the toner T having passed through the toner carrying position TCP (containing toner T that has failed to be transferred to the development roller 61 and toner T scraped off from the development roller 61 by the below-mentioned retrieving member 63) to a toner storage room TR2 disposed adjacent to the toner storage room TR1. The electric-field transfer board 62 is formed to protrude toward the development roller 61 around the toner carrying position TCP, such that the toner transfer surface TTS faces outward to be opposed to the development roller 61 in the toner carrying position TCP.

Further, in the embodiment, the electric-field transfer board 62 includes a substantially flat section configured to transfer the toner T vertically up from the toner storage room TR1 toward the toner carrying position TCP, and a substantially flat section configured to transfer the toner T vertically down from the toner carrying position TCP toward the toner storage room TR2. Furthermore, the electric-field transfer board 62 is configured such that a toner transfer direction TTD thereof is opposite to the moving direction of the circumferential surface of the development roller 61 in the toner carrying position TCP.

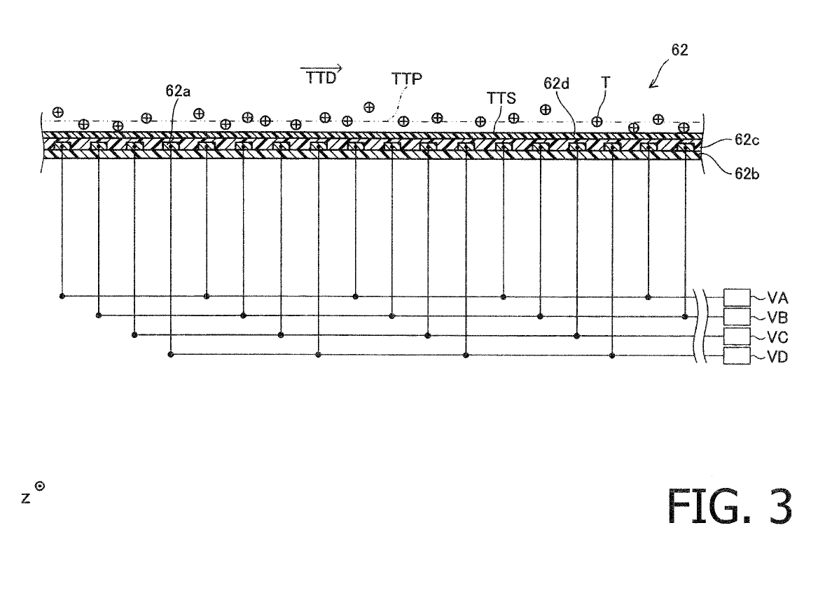

FIG. 3 is a cross-sectional side view showing the electric-field transfer board 62 in an enlarged manner. As shown in FIG. 3, the electric-field transfer board 62 is a thin plate member configured in the same manner as a flexible printed-circuit board. Specifically, the electric-field transfer board 62 includes a plurality of transfer electrodes 62a, a transfer electrode supporting film 62b, a transfer electrode coating layer 62c, and a transfer electrode overcoating layer 62d.

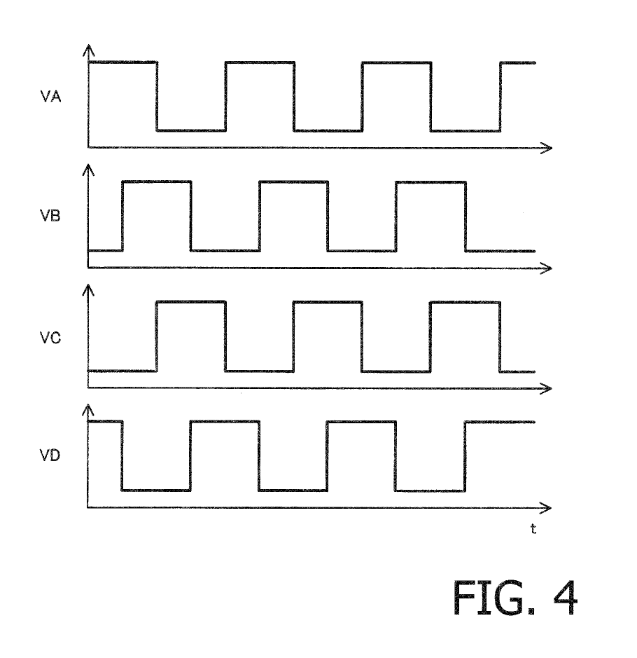

The transfer electrodes 62a are linear wiring patterns elongated in a direction parallel to the main scanning direction. The transfer electrodes 62a are formed with copper thin films. The transfer electrodes 62a are arranged along the toner transfer path TTP so as to be parallel to each other. Every fourth one of the transfer electrodes 62a, arranged along the toner transfer path TTP, is connected with a specific one of four power supply circuits VA, VB, VC, and VD. In other words, the transfer electrodes 62a are arranged along the toner transfer path TTP in the following order: a transfer electrode 62a connected with the power supply circuit VA, a transfer electrode 62a connected with the power supply circuit VB, a transfer electrode 62a connected with the power supply circuit VC, a transfer electrode 62a connected with the power supply circuit VD, a transfer electrode 62a connected with the power supply circuit VA, a transfer electrode 62a connected with the power supply circuit VB, a transfer electrode 62a connected with the power supply circuit VC, a transfer electrode 62a connected with the power supply circuit VD, . . . . In the embodiment, as shown in FIG. 4, the power supply circuits VA, VB, VC, and VD are configured to generate respective AC driving voltages having substantially the same waveform. Further, the power supply circuits VA, VB, VC, and VD are configured to generate the respective AC driving voltages with a phase difference of 90 degrees between any adjacent two of the power supply circuits VA, VB, VC, and VD in the aforementioned order. In other words, the power supply circuits VA, VB, VC, and VD are configured to output the respective AC driving voltages each of which is delayed by a phase of 90 degrees behind the voltage output from a precedent adjacent one of the power supply circuits VA, VB, VC, and VD in the aforementioned order.

The transfer electrodes 62a are formed on a surface of the transfer electrode supporting film 62b. The transfer electrode supporting film 62b is a flexible film made of electrically insulated synthetic resin such as polyimide resin. The transfer electrode coating layer 62c is provided to coat the transfer electrodes 62a and the surface of the transfer electrode supporting film 62b on which the transfer electrodes 62a are formed. In the embodiment, the transfer electrode coating layer 62c is made of polyimide resin. On the transfer electrode coating layer 62c, the transfer electrode overcoating layer 62d is provided. The surface (the toner transfer surface TTS) of the transfer electrode overcoating layer 62d is formed as a smooth surface with a very low level of irregularity, so as to smoothly convey the toner T.

Referring back to FIG. 2, the retrieving member 63 is disposed to contact the development roller 61 in a position downstream relative to the development position DP and upstream relative to the toner carrying position TCP in the moving direction of the circumferential surface of the development roller 61, so as to retrieve the toner T that remains on the development roller 61 after having passed through the development position DP. In the embodiment, the retrieving member 63 is a plate member referred to as a “flicker.” The retrieving member 63 is disposed downstream relative to the toner carrying position TCP in the toner transfer direction TTD (in other words, above the toner storage room TR2).

The toner storage room TR1 accommodates the auger 64. In addition, the toner storage room TR2 accommodates the auger 65. The augers 64 and 65 are configured to, when driven to rotate, agitate and circulate the toner T stored in the toner storage rooms TR1 and TR2, respectively.

The electric-field transfer board 62 is electrically connected with the transfer bias supply circuit 66. The transfer bias supply circuit 66 is configured to output a transfer bias (see FIG. 4) for transferring the toner T from the toner storage room TR1 to the toner storage room TR2 in the toner transfer direction TTD along the toner transfer path TTP. Specifically, the transfer bias supply circuit 62 is configured to output a transfer voltage (+300-+900 V) containing a DC voltage component of +600 V and four-phase AC voltage components with an amplitude of 300 V and a frequency of 300 Hz.

The development roller 61 is electrically connected with the development bias supply circuit 67. The development bias supply circuit 67 is configured to output a voltage required for applying a development bias to between the development roller 61 and the photoconductive drum 3. Specifically, the development bias supply circuit 67 is configured to output a DC voltage of +300 V.

<Operations>

Subsequently, an explanation will be provided about a general overview of operations and effects of the toner supply device 6.

In the embodiment, the positively charged toner T is transferred, by the electric-field transfer board 62, from the toner storage room TR1 to the toner carrying position TCP in the toner transfer direction TTD along the toner transfer path TTP. Then, the toner T is transferred onto and carried on the development roller 61 in the toner carrying position TCP.

At this time, the toner T is transferred onto and carried on the development roller 61 in the situation where the toner transfer surface TTS contacts the development roller 61 (which is a brush roller) in the toner carrying position TCP. Therefore, most of the toner T conveyed to the toner carrying position TCP is transferred onto the development roller 61 and evenly carried on the development roller 61 in a favorable manner.

The toner T, which has been transferred onto and carried on the development roller 61 in the toner carrying position TCP, is conveyed to the development position DP by the rotation of the development roller 61. Then, the toner T is supplied to the photoconductive drum 3 in the development position DP (in order to develop the electrostatic latent image formed on the electrostatic latent image carrying surface LS). The toner T, which remains after having passed through the development position DP, is removed by the retrieving member 63. Thus, the toner T, dropped into the toner storage room TR2, is retrieved. Thereby, a development record (a trace of the toner T supplied to the photoconductive drum 3) formed in the development position DP is cleared in a favorable manner from the circumferential surface of the development roller 61 on which the toner T remains after having passed through the development position DP. The toner T, which has been retrieved and stored in the toner storage room TR2, is agitated by the auger 65 to be mixed with the toner T earlier stored in the toner storage room TR2. Then, the toner T is again conveyed from the toner storage room TR2 to the toner storage room TR1.

Thus, according to the embodiment, the toner T, which is charged in a so preferred manner as to be transferred in a favorable manner by the traveling-wave electric field, is transferred to the toner carrying position TCP by the electric-field transfer board 62. Then, the toner is transferred onto and carried on the development roller 61 in the toner carrying position TCP. Hence, it is possible to achieve a more stable charge state of the charged toner T to be carried on the development roller 61 (which is a brush roller) than the aforementioned known developer supply device. Therefore, according to the embodiment, it is possible to achieve an inexpensive configuration for the toner supply device 6 to supply the toner T to the photoconductive drum 3 in a favorable manner.

Additionally, in the embodiment, the toner T is supplied, in the toner carrying position TCP, to the development roller 61 of which the circumferential surface is moving in the direction opposite to the toner transfer direction TTD in the toner carrying position TCP. Further, the toner T, which remains after having passed through the development position DP, is retrieved by the retrieving member 63 that contacts the development roller 61 in the position downstream relative to the development position DP and upstream relative to the toner carrying position TCP in the moving direction of the circumferential surface of the development roller 61. Thus, according to the embodiment, it is possible to transfer the toner T onto the development roller 61 and retrieve the toner T from the development roller 61 in a favorable manner.

Hereinabove, the embodiment according to aspects of the present invention has been described. The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without reapportioning to the details specifically set forth. In other instances, well known processing structures have not been described in detail, in order not to unnecessarily obscure the present invention.

Only an exemplary embodiment of the present invention and but a few examples of their versatility are shown and described in the present disclosure. It is to be understood that the present invention is capable of use in various other combinations and environments and is capable of changes or modifications within the scope of the inventive concept as expressed herein. For example, the following modifications are possible.

### <Modifications>

Aspects of the present invention may be applied to electrophotographic image forming devices such as color laser printers, and monochrome and color copy machines, as well as the single-color laser printer as exemplified in the aforementioned embodiment. Further, the photoconductive body is not limited to the drum-shaped one as exemplified in the aforementioned embodiment. For instance, the photoconductive body may be formed in a shape of a plate or an endless belt.

Additionally, light sources (e.g., LEDs, electroluminescence devices, and fluorescent substances) other than a laser scanner (for the scanning unit 5) may be employed as light sources for exposing the photoconductive drum 3. In such cases, the “main scanning direction” may be parallel to a direction in which light emitting elements such as LEDs are aligned. Furthermore, aspects of the present invention may be applied to image forming devices employing methods (such as a toner-jet method using no photoconductive body, an ion flow method, and a multi-stylus electrode method) other than the aforementioned electrophotographic method.

The development roller 61 may be disposed away from the photoconductive drum 3. Further, the development roller 61 may be disposed away from the toner transfer surface TTS. Moreover, the configuration of the development roller 61 (e.g., the material, size, density, and length for the fibers) is not limited to the configuration exemplified in the aforementioned embodiment.

The voltages generated by the power supply circuits VA, VB, VC, and VD may have an arbitrary waveform (e.g., a sinusoidal waveform and a triangle waveform) other than the rectangle waveform as exemplified in the aforementioned embodiment. Further, in the aforementioned embodiment, the four power supply circuits VA, VB, VC, and VD are provided to generate the four-phase AC voltages with a phase difference of 90 degrees between any adjacent two of the power supply circuits VA, VB, VC, and VD in the aforementioned order. However, three power supply circuits may be provided to generate three-phase AC voltages with a phase difference of 120 degrees between any two of the three power supply circuits.

The configuration and the location of the electric-field transfer board 62 are not limited to those exemplified in the aforementioned embodiment. For example, a portion of the electric-field board 62 around the toner carrying position TCP may be formed in a flat plate shape or a convex shape along a toner carrying surface TCS that is the circumferential surface of the development roller 61.

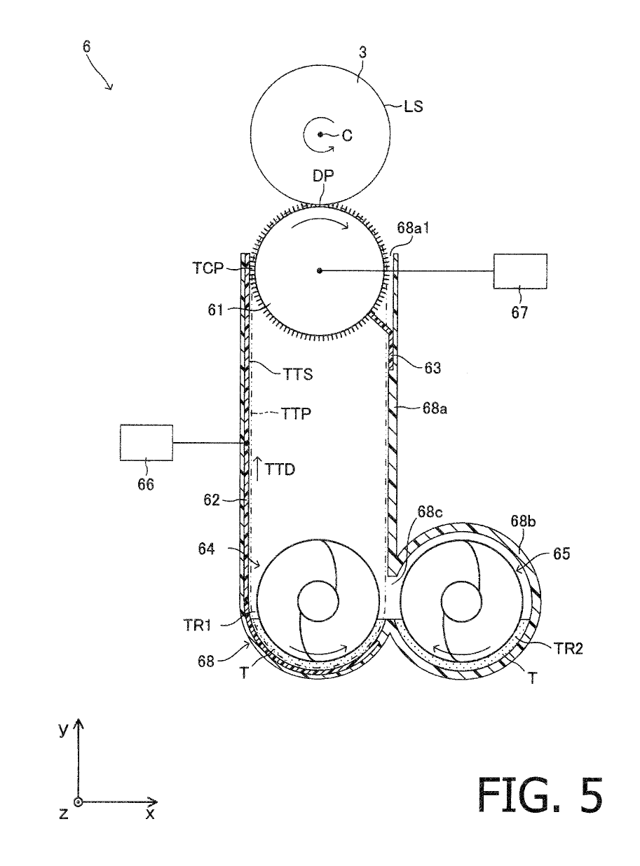

FIG. 5 is a cross-sectional side view schematically showing a configuration of a toner supply device 6 in a modification according to aspects of the present invention. As shown in FIG. 5, the electric-field transfer board 62 may be configured to supply the toner T to the development roller 61 of which the circumferential surface is moving in the same as the toner transfer direction TTD in the toner carrying position TCP.

Specifically, in the modification, a casing 68, which forms a main body frame of the toner supply device 6, may include a main casing 68a that is a box-shaped member formed substantially in a U-shape elongated in the vertical direction (the y-axis direction in FIG. 5) when viewed along the z-axis direction. Namely, the main casing 68a may include an opening 68a1 formed at an upper end portion of the main casing 68a opposite the photoconductive drum 3. The opening 68a1 may be formed to open up toward the photoconductive drum 3. There may be a toner storage room TR1 formed inside a substantially half-cylindrical bottom portion of the main casing 68a.

The casing 68 may further include a substantially cylindrical sub casing 68b that has a center axis line parallel to the main scanning direction and may be formed in parallel with the bottom portion of the main casing 68a. Inside the sub casing 68b, a toner storage room TR2 may be formed. The toner storage room TR1 inside the bottom portion of the main casing 68a and the toner storage room TR2 inside the sub casing 68b may be joined with each other via a communication hole 68c so as to be in communication with each other.

An auger 64 may be disposed inside the bottom portion of the main casing 68a. Further, an auger 65 may be disposed inside the sub casing 68b. The augers 64 and 65 may be configured to agitate and circulate the toner T in the toner storage rooms TR1 and TR2.

The development roller 61 may be housed in the casing 68 such that the center axis of the development roller 61 is placed inside the main casing 68a and an upper half portion of the development roller 61 is substantially exposed to the outside of the main casing 68a. Further, the development roller 61 may be rotatably supported at the upper end portion of the main casing 68a where the opening 68a1 is formed.

In the main casing 68a, an electric-field transfer board 62 may be provided along a toner transfer path TTP formed substantially in an oval shape elongated in the vertical direction when viewed along the z-axis direction in FIG. 5. The electric-field transfer board 62 may be fixed onto an inner wall surface of the main casing 68a at a side facing the communication hole 68c across the toner storage room TR1.

The electric-field transfer board 62 may be fixed onto the inner wall surface of the main casing 68a across an area from a bottom surface of the toner storage room TR1 that is formed substantially in a half-cylinder shape opening upward to a vertically extending surface that faces the development roller 61. In the modification, the electric-field transfer board 62 may be formed integrally in a seamless manner, in a mirror-reversed J-shape when viewed along the z-axis direction in FIG. 5. An upper end of the electric-field transfer board 62 may be as high as the center of the development roller 61. The electric-field transfer board 62 may be configured to transfer the toner T stored in the toner storage room TR1 vertically up toward the toner carrying position TCP.

A retrieving member 63 may be fixed onto an inner wall surface of the main casing 68a at a side where the communication hole 68c is provided (i.e., at a side facing the electric-field transfer board 62 across the toner storage room TR1).

According to the modification, the toner T is transferred onto and carried on the development roller 61 inside the casing 68 (the main casing 68a). Further, the toner T is retrieved from the development roller 61 inside the casing 68 (the main casing 68a). Therefore, it is possible to prevent, in a favorable manner, the toner T from leaking out of the toner supply device 6.

What is claimed is:

1. A developer supply device configured to supply charged development agent to an intended device, comprising:
a developer storage section configured to store the development agent to be supplied;
an electric-field transfer board comprising a plurality of transfer electrodes arranged along a developer transfer path in parallel with each other, the electric-field transfer board being configured to transfer the development agent stored in the developer storage section along the developer transfer path when the plurality of transfer electrodes are supplied with a multi-phase alternating-current voltage; and
a brush roller disposed to face the intended device in a predetermined developer supply position and face the electric-field transfer board in a predetermined developer carrying position, the brush roller being configured to receive the development agent from the electric-field transfer board in the predetermined developer carrying position and carry the received development agent to the predetermined developer supply position where the development agent is supplied to the intended device.

2. The developer supply device according to claim 1,
wherein the brush roller is disposed to contact the electric-field transfer board in the predetermined developer carrying position.

3. The developer supply device according to claim 1, further comprising a retrieving member disposed to contact the brush roller, the retrieving member being configured to retrieve the development agent that remains on the brush roller after having passed through the predetermined developer supply position.

4. The developer supply device according to claim 3,
wherein the electric-field transfer board is formed to protrude toward the brush roller around the predetermined developer carrying position,
wherein the brush roller is configured to rotate such that a circumferential surface thereof moves in a direction opposite to a transfer direction in which the development agent is transferred by the electric-field transfer board, and
wherein the retrieving member is disposed to contact the brush roller in a position downstream relative to the predetermined developer supply position and upstream relative to the developer carrying position in the moving direction of the circumferential surface of the brush roller.

5. The developer supply device according to claim 1,
wherein the electric-field transfer board comprises a flat section configured to transfer the development agent vertically up from the developer storage section toward the developer carrying position.

6. An image forming apparatus comprising:
an image carrying body configured to carry an electrostatic latent image; and
a developer supply device configured to supply charged development agent to the image carrying body to develop the electrostatic latent image carried on the image carrying body, the developer supply device comprising:
a developer storage section configured to store the development agent to be supplied;
an electric-field transfer board comprising a plurality of transfer electrodes arranged along a developer transfer path in parallel with each other, the electric-field transfer board being configured to transfer the development agent stored in the developer storage section along the developer transfer path when the plurality of transfer electrodes are supplied with a multi-phase alternating-current voltage; and
a brush roller disposed to face the intended device in a predetermined developer supply position and face the electric-field transfer board in a predetermined developer carrying position, the brush roller being configured to receive the development agent from the electric-field transfer board in the predetermined developer carrying position and carry the received development agent to the predetermined developer supply position where the development agent is supplied to the intended device.

7. The image forming apparatus according to claim 6,
wherein the brush roller is disposed to contact the electric-field transfer board in the predetermined developer carrying position.

8. The image forming apparatus according to claim 6, further comprising a retrieving member disposed to contact the brush roller, the retrieving member being configured to retrieve the development agent that remains on the brush roller after having passed through the predetermined developer supply position.

9. The image forming apparatus according to claim 8,
wherein the electric-field transfer board is formed to protrude toward the brush roller around the predetermined developer carrying position,
wherein the brush roller is configured to rotate such that a circumferential surface thereof moves in a direction opposite to a transfer direction in which the development agent is transferred by the electric-field transfer board, and
wherein the retrieving member is disposed to contact the brush roller in a position downstream relative to the predetermined developer supply position and upstream relative to the developer carrying position in the moving direction of the circumferential surface of the brush roller.

10. The image forming apparatus according to claim 6,
wherein the electric-field transfer board comprises a flat section configured to transfer the development agent vertically up from the developer storage section toward the developer carrying position.
